(19) United States
(12) Patent Application Publication
(10) Pub. No.: US 2006/0289777 A1
(43) Pub. Date: Dec. 28, 2006

(54) Detector with electrically isolated pixels

(76) Inventors: Wen Li, Clifton Park, NY (US); George Edward Possin, Schenectady, NY (US); Gregory Scott Zeman, Waukesha, WI (US); James Walter Leblanc, Niskayuna, NY (US); Jonathan David Short, Saratoga Springs, NY (US); Rogerio Geraldes Rodrigues, Clifton Park, NY (US)

Correspondence Address: Patrick S. Yoder;FLETCHER YODER, P.O. Box 692289, Houston, TX, 77269-2289, US

(21) Appl. No.: 11/171,170

(22) Filed: Jun. 29, 2005

(51) Int. Cl. G01T 1/24

(52) U.S. Cl. 250/370.14

(57) ABSTRACT

In accordance with an implementation of the present technique, a detector is disclosed. The detector includes a photodetector array and a substrate layer. The photodetector array includes a plurality of photodiodes and a structure of trenches or diffusions grids that electrically isolate each photodiode of the plurality of photodiodes. The plurality of photodiodes and the structure of trenches or deep diffusions grids are disposed on a first surface of the photodetector array and a second surface opposite the first surface is bonded to a substrate layer. The substrate layer is typically made of the same semiconductor material as the photodetector array but heavily doped and conductive to provide cathode contact to the photodetector array in addition to mechanical support.

### BACKGROUND

The invention relates generally to the field of non-invasive imaging and more particularly to the use of detectors composed of photodiode arrays in such imaging techniques.

The field of non-invasive imaging has wide ranging applications in the areas of medical, industrial, and security imaging. For example, in modern healthcare facilities, medical diagnostic and imaging systems are invaluable for diagnosing and treating physical conditions and disorders inside the human body. Similarly, in industrial applications, non-invasive imaging is a valuable tool for scanning various objects for quality control and defect recognition. Likewise, in security applications, non-invasive imaging allows package, baggage, and even passenger screening to be performed in a non-invasive, unobtrusive, and rapid manner.

For example, one class of non-invasive imaging techniques that may be used in these various fields is based on the differential transmission of X-rays through a patient or object. In the medical context, a simple X-ray imaging technique may involve generating X-rays using an X-ray tube or other source and directing the X-rays through an imaging volume in which the part of the patient to be imaged is located. As the X-rays pass through the patient, the X-rays are attenuated based on the composition of the tissue they pass through. The attenuated X-rays then impact a detector that converts the X-rays into signals that can be processed to generate an image of the part of the patient through which the X-rays passed based on the attenuation of the X-rays. Typically the X-ray detection process utilizes a scintillator, which generates optical photons when impacted by X-rays, and an array of photosensor elements, which generate electrical signals based on the number of optical photons detected. Typically the array of photosensor elements is an array of photodiodes where each photodiode is equated to a picture element, or pixel, in images generated using the detector.

One problem that may arise in the detection process occurs when one of the photodiodes used to detect optical photons is open, i.e., does not form a closed circuit. During imaging operations such an open photodiode may continue to accumulate charge, which is eventually injected to neighboring photodiodes as a bipolar diffusion current. Such diffusion currents interfere with the operation of the neighboring pixels. As a result, an open photodiode in the middle of an array of photodiodes may interfere with the operation of nine pixels, i.e., the open photodiode itself as well as the eight adjacent photodiodes.

For a single bad pixel, interpolation based on nearby good pixels may be used to provide some degree of correction. However, where an entire 3×3 array of pixels is impacted by the effect of an open photodiode, it may be difficult or impossible to obtain the desired degree of correction based solely on interpolation. Similarly, calibration may be helpful in mitigating the effects of an open photodiode to some extent. However, due to the dependence of the injected diffusion current on varying environmental factors such as signal level and temperature, calibration may be insufficient for satisfactory correction.

The problems created by open photodiodes are undesirable in larger, higher resolution detector arrays comprising more and smaller photodiodes assemblies. For example, in multi-slice computed tomography (CT) systems, where the CT scanner is able to acquire more than one image slice simultaneously, the detector size is large and is of high complexity. As the complexity of the photodiode array increases in such detectors, it becomes increasingly difficult to properly connect every photodiode in the arrays. As a result, the increasing size and complexity of multi-slice CT arrays may result in open photodiodes that degrade image quality around them. Similarly, detectors in other X-ray imaging modalities, such as radiography, mammography, tomography, and so forth may suffer from similar detector quality problems as detector size and/or complexity increases.

Thus, there is a need for a technique that prevents open photodiodes from contaminating neighboring photodiodes in a detector array.

### BRIEF DESCRIPTION

In accordance with an implementation of the present technique, a detector is disclosed. The detector includes a photodetector array. The photodetector array includes a plurality of photodiodes and an electrically isolating structure separating each photodiode of the plurality of photodiodes.

In accordance with another implementation of the present technique, a method of manufacturing a detector is disclosed. The method involves providing a photodetector array that includes a plurality of photodiodes. The method also involves separating each photodiode of the plurality of photodiodes with an electrically isolating structure.

In accordance with yet another implementation of the present technique, an imaging system is disclosed. The imaging system includes a radiation source configured to emit radiation and a detector that is configured to generate a plurality of signals in response to the emitted radiation. The detector in the imaging system further includes a photodetector array having a plurality of photodiodes and an electrically isolating structure separating each photodiode of the plurality of photodiodes.

In accordance with yet another implementation of the present technique, a method for electrically connecting a photodiode array is disclosed. The method involves providing a plurality of vias through the photodiode array. Further, the method involves electrically connecting each via to a respective photodiode of the plurality of photodiodes and electrically connecting each via to readout circuitry configured to acquire signals from at least one of the photodiodes at a time.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of an exemplary imaging system operating in accordance with one embodiment of the present technique;

FIG. 2 is an exemplary depiction of a multi-slice computed tomography system in accordance with certain implementations of the present technique;

FIG. 3 is a diagrammatical illustration of an exemplary detector module in accordance with certain implementations of the present technique;

FIG. 4 is a diagrammatical illustration of an exemplary detector array in accordance with one embodiment of the present technique;

FIG. 5 is a diagrammatical illustration of an exemplary detector array in accordance with another embodiment of the present technique;

FIG. 6 is a diagrammatical illustration of an exemplary detector array in accordance with a further embodiment of the present technique;

FIG. 7 is a diagrammatical illustration of an exemplary detector array in accordance with an additional embodiment of the present technique;

FIG. 8 is a diagrammatical illustration of yet an exemplary detector array in accordance with another embodiment of the present technique;

FIG. 9 is a diagrammatical illustration of an interconnect structure in accordance one embodiment of the present technique; and

FIG. 10 is an exemplary depiction of an interconnect structure in accordance with another embodiment of the present technique.

### DETAILED DESCRIPTION

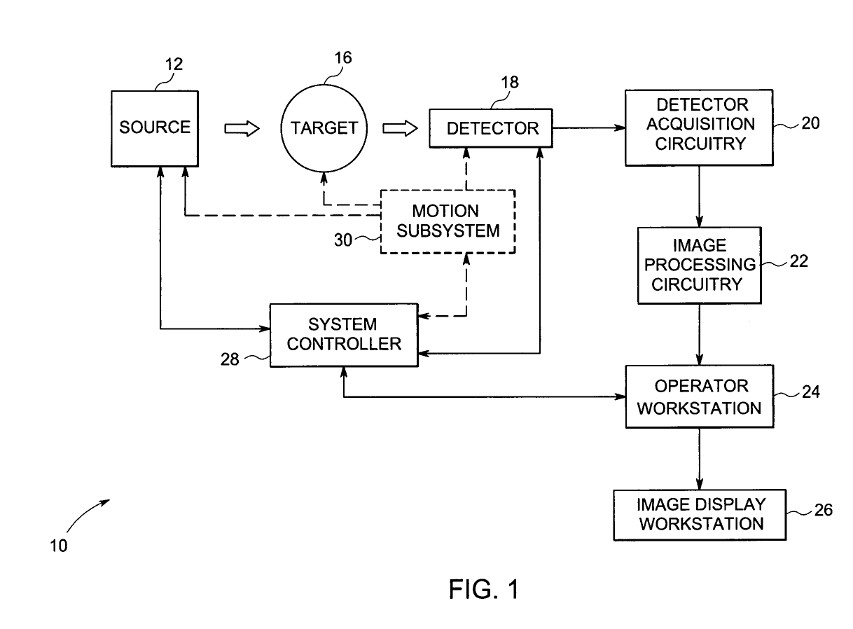

Turning now to the drawings and referring first to FIG. 1, an exemplary imaging system 10 operating in accordance with certain aspects of the present technique is illustrated.

The imaging system 10 includes a source 12 adapted to emit X-rays through a target 16 disposed within an imaging volume. After passing through the target 16 the X-rays impact a detector 18 which generates signals in response to the incident X-rays. The signals may be acquired by detector acquisition circuitry 20 and processed by image processing circuitry 22 to generate one or more images for display on an operator workstation 24 or an image display workstation 26. The imaging system 10 also includes a system controller 28 adapted to communicate with at least the X-ray source 12, the detector 18 and the operator workstation 24. In certain implementations of the present technique, the imaging system 10 may also include a motion subsystem 30 that is controlled by the system controller 28 and adapted to control the motion of at least the X-ray source 12 and/or the detector 18. Alternatively, in other embodiments, the motion subsystem 30 may be adapted to control the motion of the target 16 (or a support on which the target 16 rests) in addition to or instead of the motion of the X-ray source 12 and/or the detector 18. As will be appreciated by those of ordinary skill in the art, the operator workstation 24 may be configured to communicate with the system controller 28 to control the operation of source 12, the detector acquisition circuitry 20, and/or the motion subsytem 30, if present.

In the present exemplary embodiment, the source 12 is configured to emit X-rays. However, in other embodiments, the source may be configured to generate electromagnetic energy at wavelengths outside what is considered to be the X-ray energy spectrum (such as gamma ray, visible or near visible) known in the art at an appropriate wavelength and intensity such that the electromagnetic energy may be used for imaging (such as by transmission or reflection) in conjunction with a suitable detector 18. Furthermore, in certain other implementations, it should be noted that the functions of some or all of the detector acquisition circuitry 20, the image processing circuitry 22, the operator workstation 24, the image display workstation 26, the system controller 28 as well as the motion subsystem 30 may be grouped into a single unit or various sub-units and that such modifications should be construed as being within the scope of the present technique. For example, in one embodiment the functions of the system controller 28, image processing circuitry 22, and the operator workstation 24 may be performed by a processor-based system, such as a general or special purpose computer system or workstation. In another embodiment, the functions of the operator workstation 24 and the image display workstation 26 may be performed by such a processor-based system or computer workstation

In an exemplary embodiment, the detector 18 is adapted to generate electrical signals in response to radiation, such as X-rays, incident upon the detector 18. In certain implementations, the detector 18 may be configured to generate electrical signals in direct response to the incident radiation. However, in other implementations, the detector 18 may be configured to generate the electrical signals in response to an intermediary signal generated in response to the incident radiation. For example, in one embodiment, the detector 18 includes of a scintillator array and a photodetector array. The radiation impacting the detector 18 strikes the scintillator array, which generates optical photons in response to the radiation. In such embodiments, the photodetector array may either be a front-lit photodetector or a back-lit photodetector. A front-lit photodetector is one in which the radiation first encounters the surface of the photodetector array containing the photodiodes, i.e., the “front” of the photodetector. Conversely, in back-lit photodetectors, radiation first encounters the surface of the photodetector array opposite the photodiodes, i.e., the “back side” of the photodetector. Each photodiode is configured to generate an electrical signal or charge in response to optical photons striking the photodiode. Each charge on each photodiode may then be read out to determine the incidence of optical photons, and therefore radiation, at the photodiode location. This charge information for some or all of the array may, therefore, be aggregated and processed to generate an image describing the radiation incidence on the detector at a given time. In accordance with the present technique, each photodiode of the detector 18 is electrically isolated from neighboring photodiodes such that crosstalk and diffusion currents are reduced or eliminated, thereby preventing the accumulation of charge from an open photodiode from interfering with the signal acquired from neighboring photodiodes. Different embodiments of the photodetector array in detector 18 in accordance with the present technique are discussed below.

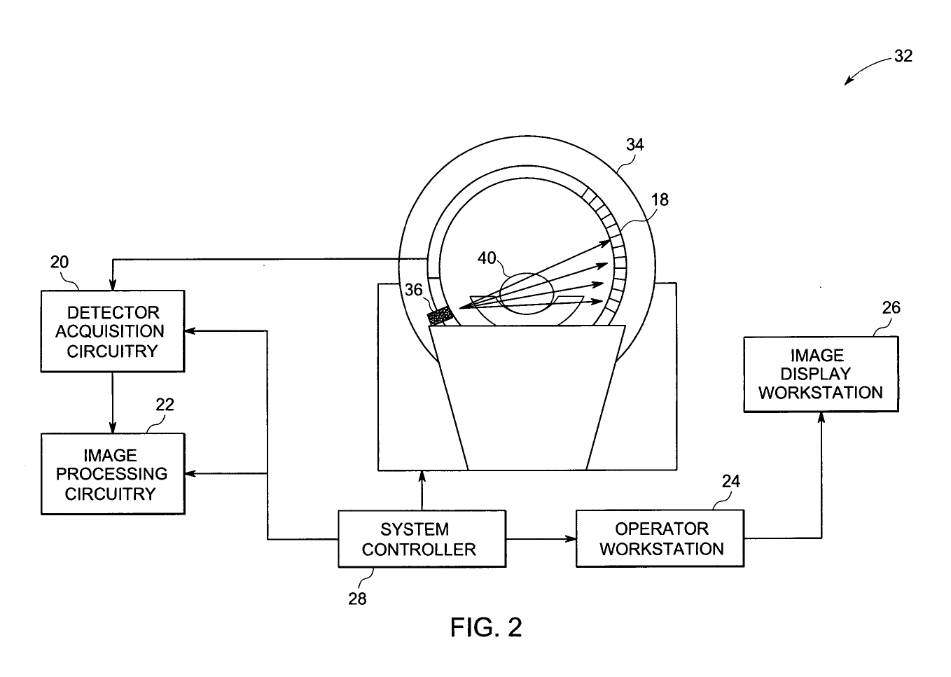

While the depicted embodiment of FIG. 1 provides a general overview of a system for use in accordance with the present invention, a specific example of such a system is provided in FIG. 2 to facilitate discussion and explanation. In particular, FIG. 2 provides an exemplary depiction of a multi-slice computer tomography (MSCT) system 32 operating in accordance with certain aspects of the present technique. The MSCT system 32 includes a housing 34 containing a source of X-rays 36 and a detector array 18. A patient 40 undergoing a scan on the MSCT system 32 is placed between the X-ray source 36 and the detector 18. The MSCT system 32 also includes detector acquisition circuitry 20, image processing circuitry 22, an operator workstation 24 and a system controller 28, as discussed with regard to FIG. 1. In addition, in the depicted embodiment, an image display workstation 26 is also present. In the exemplary embodiment, the detector 18 includes a two-dimensional array of photodiodes which are each electrically isolated from the neighboring photodiodes to reduce or eliminate diffusion currents associated with open photodiodes.

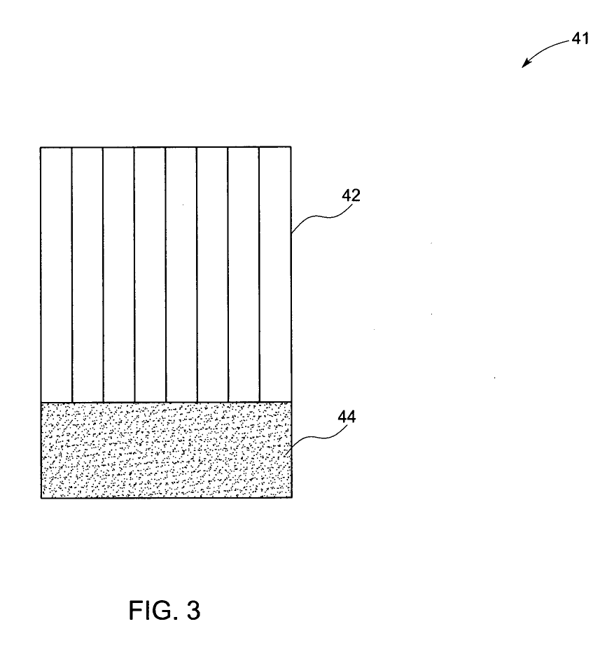

FIG. 3 is a depiction of an exemplary detector module 41 that may be used in the exemplary imaging systems 10 and/or 32 as illustrated in FIG. 1 and FIG. 2 respectfully. In particular, the respective detector 18 may be an assembly of detector modules 41 which are connected to form the respective detector 18. In this way, a problem region of the detector 18 may be addressed by replacing one or a few detector modules 41, without replacing the entire detector 18. However, it should be understood that, in the extreme, a detector 18 may be composed of a single detector module 41. In the depicted embodiment, a detector module 41 includes a scintillator layer 42 composed of a plurality of scintillator units. Likewise, in the depicted embodiment, the detector module 41 includes a photodetector array 44 composed in part of a plurality of photodiodes. Typically, each scintillator unit is associated with a corresponding photodiode. Likewise, each photodiode typically corresponds to a pixel of image data. In the certain implementations, the photodetector array 44 may be affixed to an additional substrate layer (not shown) to provide mechanical stability.

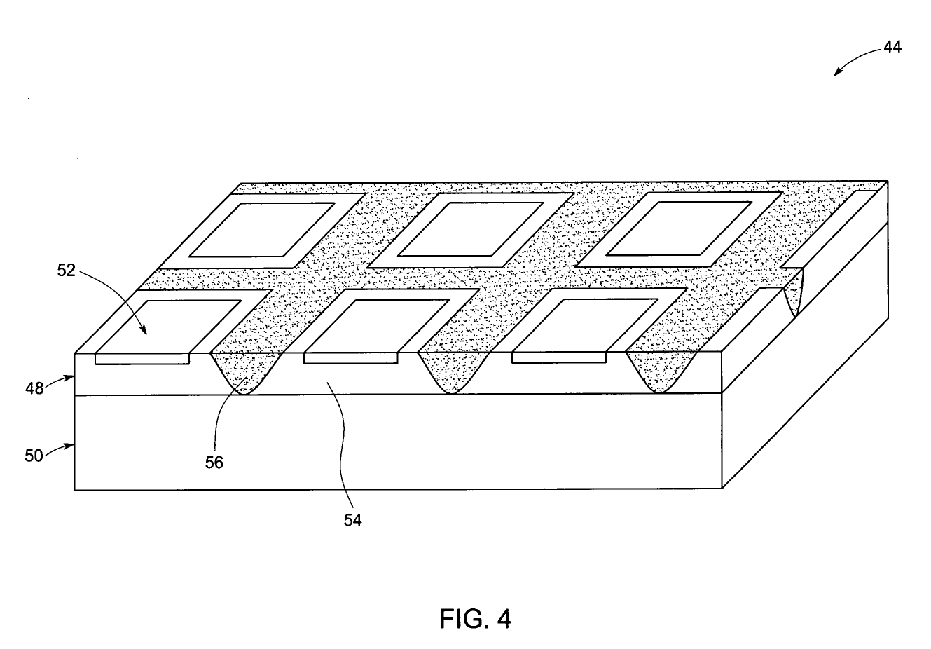

FIG. 4 is a sectional view illustrating an exemplary photodetector array 44 in accordance with certain implementations of the present technique. The depicted photodetector array 44 includes a photodiode layer 48 and a substrate layer 50 that is generally electrically conductive. For example, in one embodiment the substrate layer 50 comprises N+ doped silicon. As will be appreciated by those of ordinary skill in the art, the doping types of the substrate layer may be interchanged to P+, N− or P− doped silicon. In one embodiment, the photodiode layer 48 is substantially thinner than the substrate layer 50. In the depicted embodiment the photodiode layer 48 includes a plurality of photodiodes, each formed as a P+ layer 52 embedded in a high resistivity n-type layer 54 which is commonly referred to as the intrinsic layer although it is not truly intrinsic. The intrinsic layer 54 is typically a lightly doped form of any suitable semiconductor material suitable for use as a photodiode, such as silicon. As will be appreciated by a person skilled in the art, opting for silicon as the semiconductor of choice allows for easy pre-processing and post-processing using known techniques in the art. However, with advances in the semiconductor industry, any other suitable semiconductor material may also be appropriately used in lieu of silicon.

In the presently illustrated embodiment, each photodiode is electrically isolated from adjacent photodiodes via an N+ diffusion region 56, such as the depicted diffusion grid, which reaches down to the underlying substrate 50 to produce the electrical isolation. For example, the N+ diffusion region 56 is formed around each photodiode such that any diffusion current from an open photodiode does not flow to any neighboring photodiodes. It may be appreciated by those skilled in the art that the diffusion region may be of other doping types as well.

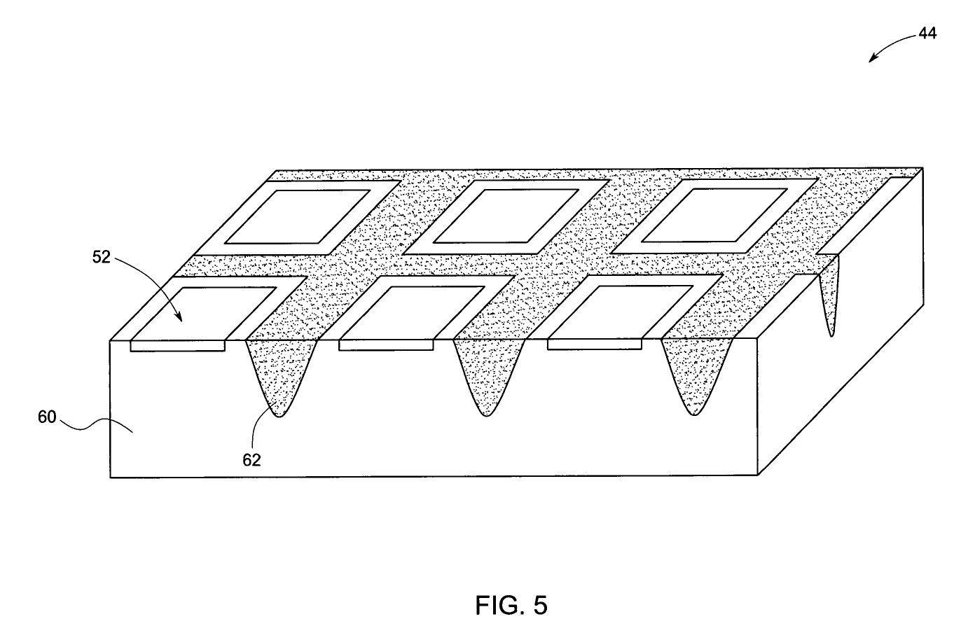

FIG. 5 is a sectional view illustrating another exemplary array 44 in accordance with certain implementations of the present technique. In the depicted embodiment, the photodetector array 44 is a single layer structure consisting generally of an intrinsic semiconductor material 60, such as silicon, on which a plurality of P+ layers, generally referred to by numeral 52, are embedded to form photodiodes. In the depicted embodiment, each photodiode pixel is partially electrically isolated from a neighboring photodiode pixel via a deep N+ diffusion region 62, such as the depicted deep diffusion grid. The diffusion of the deep N+ diffusion region 62 into the intrinsic layer 60 may be performed by techniques generally known in the art.

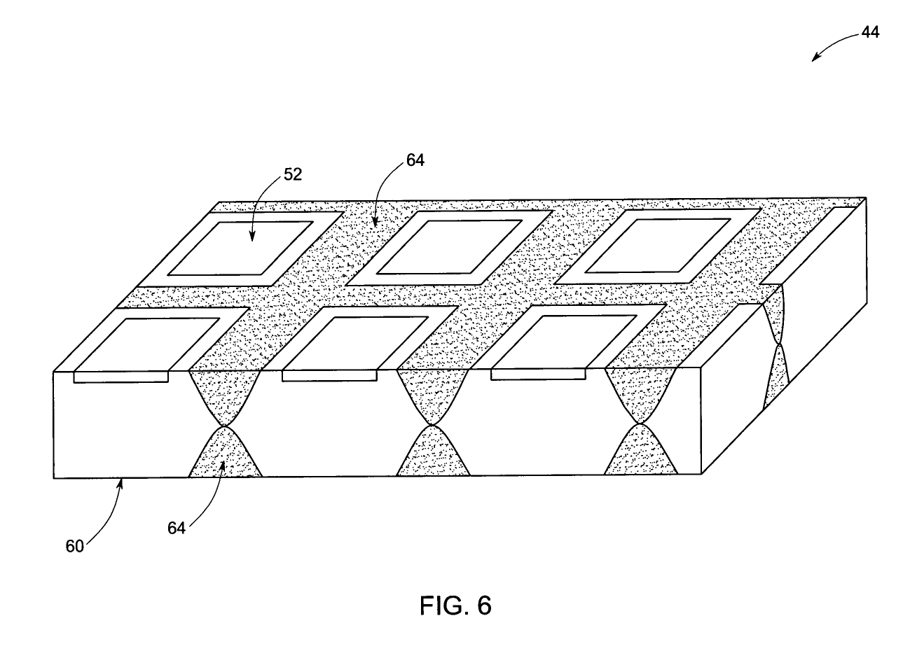

FIG. 6 is a sectional view of another exemplary photodetector array in accordance with certain other implementations of the present technique. In this embodiment, the photodetector array 44 is a single layer structure in which aligned and opposing N+ diffusion regions 64, such as the depicted diffusion grids, have been diffused such that the opposing diffusion regions contact one another within the photodetector array 44. Due to the presence of the opposing diffusion regions 64, each photodiode is electrically isolated.

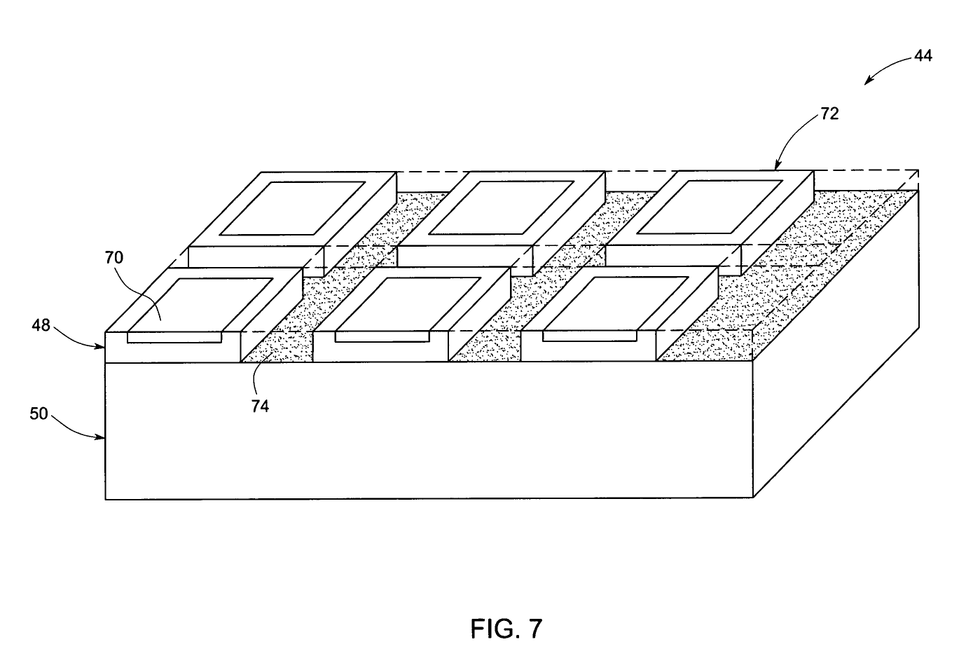

FIG. 7 is a sectional view of another exemplary photodetector array 44 in accordance with certain other implementations of the present technique. In the presently illustrated embodiment, the photodetector array 44 is a bi-layer structure that includes a photodiode layer 48 and a substrate layer 50. The photodiode layer 48 is an intrinsic layer of high resistivity semiconductor material, typically silicon, and includes a plurality of photodiodes, each generally represented by reference numeral 70. Each photodiode is formed as a P+ layer 70 embedded in the intrinsic semiconductor material, typically silicon, of the photodiode layer 48. For example, in one embodiment the substrate layer 50 comprises N+ doped silicon. Typically, the substrate 50 is formed of the same semiconductor material as the photodiode layer 48, but doped appropriately to become an N+ substrate.

In the depicted embodiment, each of the photodiodes 72 is electrically isolated from adjacent photodiodes via a trench 74 formed between each photodiode down to the substrate 50. As will be appreciated by a person skilled in the art, the trench 74 may be formed in the photodiode layer 48 by chemical or mechanical techniques such as precision mechanical sawing, etching, and so forth. Etching may be performed by chemical etching techniques, reactive ion etching, or by other etching techniques known in the art. The formation of trenches between each photodiode electrically isolates each photodiode.

In one embodiment, the sides of each trench are passivated and protected, by known methods including a thermal oxide, other deposited film or a N+ doped layer. Such passivation techniques reduce the recombination or loss of signal carriers at these surfaces and reduce the generation of leakage current in the photo diode.

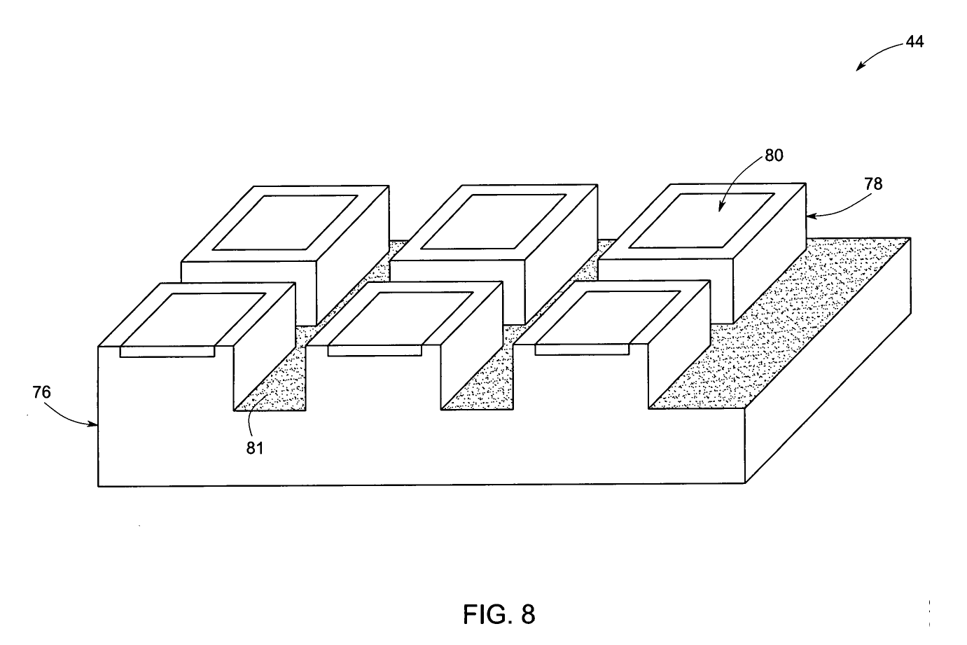

Similarly, FIG. 8 is a diagrammatical representation of yet another exemplary photodetector array 44 in accordance with yet another implementation of the present technique. In this embodiment, the photodetector array 44 is a single layer 76 formed of high resistivity semiconductor material, such as silicon. The layer 76 includes a plurality of photodiodes, each represented by reference numeral 78. Each photodiode is formed by a P+ layer 80 and the layer 76. In the depicted embodiment, each photodiode 78 is partially electrically isolated from adjacent photodiodes via a deep trench 81, which does not penetrate through the entire layer 76 of intrinsic semiconductor material. The trench 81 may be formed and passivated in the manner discussed with regard to FIG. 7.

Though the preceding discussion discusses exemplary embodiments in which each photodiode of an array of photodiodes is electrically isolated from one another, other embodiments are also possible. For example, instead of isolating each photodiode, it may instead be desirable to isolate rows or columns of photodiodes, i.e., it may be desirable to provide electrical isolation in only one-dimension, as opposed to the two-dimensional isolation schemes discussed above. As will be appreciated by those of ordinary skill in the art, in such implementations the techniques discussed herein may be employed, however, instead of a full grid of diffusion regions or trenches, the diffusion regions or trenches may be provided as parallel strips separating the photodiodes into the desired rows or columns. In this manner, each row or column of photodiodes may be electrically isolated from other respective rows or columns, but photodiodes within a respective row or column would not be electrically isolated from one another. In addition, as one of ordinary skill in the art will appreciate, the preceding examples, for simplicity, each describe only one technique for electrically isolating photodiodes. However, in other embodiments combinations of trenches and diffusion grids may be employed. For example, electrical isolation in one dimension may be accomplished via parallel strips of diffusion regions while electrical isolation in a second dimension may be accomplished via parallel trenches. Likewise, different techniques, i.e., diffusion regions and/or trenches, may be concurrently employed to achieve electrical isolation in one-dimension if so desired.

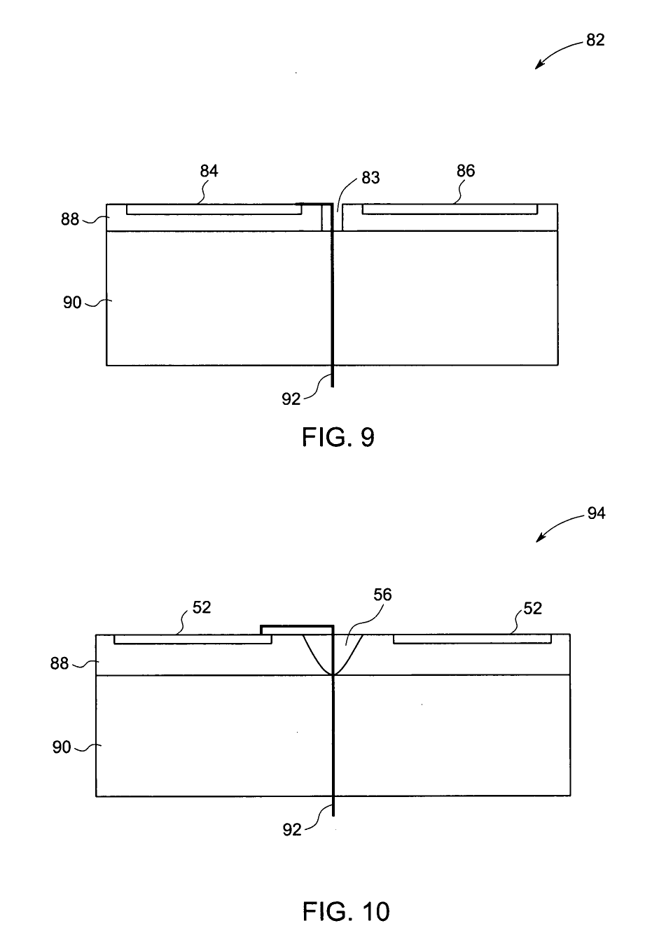

While the preceding discussion provides various techniques for electrically isolating photodiodes of a detector array, it may also be desirable to provide interconnect structures on the backside of the diodes for connecting photodiodes, electrically isolated as described herein to suitable readout circuitry, such as to the detector acquisition circuitry of FIGS. 1 and 2. For example, referring now to FIG. 9, an example of such an interconnect structure is depicted for use with an embodiment employing a trench 83 to electrically isolate adjacent photodiodes. The detector array 82, for the purposes of discussion, is shown as a bi-layered structure that includes two photodiode pixels, each containing a P+ region 84 on an intrinsic layer of high resistivity semiconductor material 88. The substrate 90 is generally affixed to the face of the intrinsic layer 88 that is opposite the face in which the P+ layers are embedded. An electrical interconnect structure or via 92 passes through the substrate 90 and the trench to contact a respective photodiode. In the present embodiment, the via 92 is adapted to provide an electrical conductive path from the P+ layer 84 across the substrate 90 and through the trench separating the two photodiode pixels. By situating via the 92 in the trench, there is very little or no reduction in the surface area on the P+ layer 84 exposed to incident optical photons or radiation. This enables an increased efficiency in the generation of image signals. Though the depicted embodiment reference a bi-layered structure, one skilled in the art will appreciate that the present interconnect technique is also applicable to embodiments employing a single layer detector layer and/or deep trenches to electrically isolate adjacent photodiodes, as discussed herein. It may also be appreciated that the vias do not necessarily pass through the trenches and may instead pass through part of the diode active area.

FIG. 10 depicts an embodiment of an interconnect structure or via 93 for use with embodiment of the present technique employing diffusions regions or grids to electrically isolate adjacent photodiodes. In this embodiment, the via 92 passes through the substrate 90 and through the diffusion region 56 in the intrinsic layer 88 to contact the photodiode formed by the P+ layer 52 and the intrinsic layer 88. As will be appreciated by those of ordinary skill in the art, the present interconnect technique is also applicable to embodiments employing a single layer detector layer, deep diffusion regions, and/or opposing diffusion regions, or trenches, to electrically isolate adjacent photodiodes, as discussed herein.

As will be appreciated by those of ordinary skill in the art, the electrical isolation techniques described herein, as well as the interconnect techniques may be used in conjunction with a detector or detector array as discussed with regard to FIGS. 1 and 2 respectively. In certain instances, the detector array may be used in the direct detection of attenuated radiation from a target. In certain other implementations, the detector array may include a scintillator array in a manner as depicted in FIG. 3. Furthermore, while the various embodiments have been discussed with silicon as the semiconductor material, it should be noted that the present technique may encompass any other suitable semiconductor material to create an effective detector array capable of detecting incident radiation. The various aspects of the present technique described herein reduce or prevent diffusion currents and cross talk currents between photodiodes, such as in the case of an open photodiode. In this manner, the effects of diffusion and other currents between photodiodes are mitigated without loss of signal for more than one photodiode. Furthermore, corrective techniques, such as interpolation, that may be suitable for one pixel but not for a block of pixels, may be employed to address the loss of signal from an electrically isolated photodiode which is not contaminating the signals of its neighbors.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A detector, comprising:
a photodetector array, comprising a plurality of photodiodes and a structure of trenches electrically isolating each photodiode of the plurality of photodiodes.

2. The detector as recited in claim 1, further comprising a substrate layer generally disposed beneath the photodetector array.

3. The detector as recited in claim 2, wherein the structure of trenches extends to the substrate layer.

4. The detector as recited in claim 2, wherein the substrate layer comprises an N+ substrate layer.

5. The detector as recited in claim 1, further comprising at least one via adapted to provide electrical contact to a backside of the photodetector array.

6. The detector as recited in claim 1, wherein each trench in the structure of trenches is passivated.

7. The detector as recited in claim 6 wherein each trench in the structure of trenches is passivated using at least an N+ layer or a thermal oxide layer

8. A detector, comprising:
a front-lit photodetector array, comprising a plurality of photodiodes and an electrically isolating structure separating each photodiode of the plurality of photodiodes.

9. The detector as recited in claim 8, wherein the electrically isolating structure comprises a structure of trenches.

10. The detector as recited in claim 8, wherein each trench in the structure of trenches is passivated using at least an N+ layer or a thermal oxide layer

11. The detector as recited in claim 8, wherein electrically isolating structure comprises a diffusion grid.

12. The detector as recited in claim 8, wherein the electrically isolating structure extends to a substrate layer, wherein the substrate layer is generally disposed below the front-lit photodetector array.

13. The detector as recited in claim 12, wherein the substrate layer comprises N+ layer.

14. The detector as recited in claim 8, further comprising at least one via configured to provide electrical contact to a backside of the photodetector array.

15. A method of manufacturing a detector, comprising:
providing a photodetector array comprising a plurality of photodiodes; and
electrically isolating each photodiode of the plurality of photodiodes with a structure of trenches.

16. The method as recited in claim 15, comprising providing a substrate layer generally disposed beneath the photodetector array.

17. The method as recited in claim 15 wherein the substrate layer comprises an N+ layer

18. The method as recited in claim 15, comprising passivating the structure of trenches.

19. The method as recited in claim 15, wherein the passivating comprises using at least an N+ layer or a thermal oxide layer in the structure of trenches.

20. The method as recited in claim 11, comprising disposing at least one via configured to provide electrical contact to a backside of the photodetector array.

21. A method of manufacturing a detector, comprising:
providing a front-lit photodetector array, comprising a front surface, a back surface, and a plurality of photodiodes disposed on the front surface; and
separating each photodiode of the plurality of photodiodes with an electrically isolating structure.

22. The method as recited in claim 21, wherein the electrically isolating structure comprises a structure of trenches.

23. The method as recited in claim 21, comprising passivating the structure of trenches using at least an N+ layer or a thermal oxide layer

24. The method as recited in claim 21, wherein electrically isolating structure comprises a diffusion grid.

25. The method as recited in claim 21, wherein the electrically isolating structure extends to a substrate layer; wherein the substrate layer is generally disposed below the front-lit photodetector array.

26. The method as recited in claim 25, wherein the substrate layer comprises an N+ layer.

27. An imaging system, comprising:
a radiation source configured to emit radiation; and
a detector configured to generate a plurality of signals in response to the emitted radiation, the detector comprising:
a photodetector array, comprising a plurality of photodiodes and a structure of trenches electrically isolating each photodiode of the plurality of photodiodes.

28. The imaging system as recited in claim 27, wherein the structure of trenches extends to a substrate layer; wherein the substrate layer is generally disposed beneath the photodetector array.

29. The imaging system as recited in claim 28 wherein the substrate layer comprises an N+ layer.

30. The imaging system as recited in claim 27, wherein the detector further comprises at least one via configured to provide electrical contact to a backside of the photodetector array.

31. An imaging system, comprising:
a radiation source configured to emit radiation; and
a detector configured to generate a plurality of signals in response to the emitted radiation, the detector comprising:
a front-lit photodetector array, comprising a plurality of photodiodes and an electrically isolating structure separating each photodiode of the plurality of front-lit photodiodes.

32. The imaging system as recited in claim 31, wherein the electrically isolating structure comprises a structure of trenches.

33. The imaging system as recited in claim 32, wherein the structure of trenches are passivated using at least an N+ layer or a thermal oxide layer.

34. The imaging system as recited in claim 31, wherein electrically isolating structure comprises a diffusion grid.

35. The imaging system as recited in claim 31, wherein the electrically isolating structure extends to a substrate layer; wherein the substrate layer is generally disposed below the front-lit photodetector array.
